(19) United States
(12) Patent Application Publication
(10) Pub. No.: US 2010/0095384 A1
(43) Pub. Date: Apr. 15, 2010

(54) Realest Invention

(76) Inventor: Theodoros H. Asimakopoulos, Silver Spring, MD (US)

Correspondence Address: Theodoros Asimakopoulos, 3703 Jeffry St., Silver Spring, MD, 20906, US

(21) Appl. No.: 12/456,897

(22) Filed: Jun. 24, 2009

Related U.S. Application Data
(60) Provisional application No. 61/076,637, filed on Jun. 28, 2008.

(51) Int. Cl. G06F 7/04

(52) U.S. Cl. 726/30

(57) ABSTRACT

The new process (invention) named the realest invention is a new process in which information is stored on the computer. Information is stored in bulk at a policing agency. What this policing agency does is store drivers license, birth certificate and social security and others of this like. This enables for added security to the theft of music and movies on the internet. What the policing agency does is check to make sure that every thing is legate on the website individual is putting on the internet. Majority of times people use credit card and check and a thorough check can be done to make sure every thing matches on the website that they are putting on the internet.

The new process (invention) named the realest invention is a new process in which information is stored on the computer. Information is stored in bulk at a policing agency. What this policing agency does is store drivers license, birth certificate and social security and others of this like. This enables for added security to the theft of music and movies on the internet. What the policing agency does is check to make sure that every thing is legate on the website individual is putting on the internet. Majority of times people use credit card and check and a thorough check can be done to make sure every thing matches on the website that they are putting on the internet.

### BACKGROUND OF THE INVENTION

Storing on a computer is no new thing but the magnitude of storing on many computers and having access to check to make sure every thing is legate is a new and useful process.

### BRIEF SUMMARY OF THE INVENTION

The new process (invention) named the realest invention is a new process in which information is stored on the computer. Information is stored in bulk at a policing agency. What this policing agency does is store drivers license, birth certificate and social security and others of this like. This enables for added security to the theft of music and movies on the internet. What the policing agency does is check to make sure that every thing is legate on the website individual is putting on the internet. Majority of times people use credit card and check and a thorough check can be done to make sure every thing matches on the website that they are putting on the internet.

### DETAILED DESCRIPTION OF THE INVENTION

The new process (invention) named the realest invention is a new process in which information is stored on the computer. Information is stored in bulk at a policing agency. What this policing agency does is store drivers license, birth certificate and social security and others of this like. This enables for added security to the theft of music and movies on the internet. What the policing agency does is check to make sure that every thing is legate on the website individual is putting on the internet. Majority of times people use credit card and check and a thorough check can be done to make sure every thing matches on the website that they are putting on the internet

1. Stored mass on computers, what is stored is drivers license, birth certificate, social security and other of the likes in order to fight theft and make it easy to check that everything on internet is legate.
